(19) United States
(12) Patent Application Publication
(10) Pub. No.: US 2021/0306175 A1
(43) Pub. Date: Sep. 30, 2021

(54) TELEMETRY BASED ON HFC DISTRIBUTION NETWORK INFRASTRUCTURE

(71) Applicant: ARRIS Enterprises LLC, Suwanee, GA (US)

(72) Inventors: Sergio Alfredo Mendoza Aguirre, Excobedo (MX); Joaquin Beas, Poway, CA (US)

(21) Appl. No.: 17/054,107

(22) PCT Filed: May 8, 2019
(86) PCT No.: PCT/US2019/031336

§ 371 Date: Nov. 9, 2020

Related U.S. Application Data
(60) Provisional application No. 62/668,444, filed on May 8, 2018.

(51) Int. Cl. H04L 12/28; H04B 17/14; H04B 17/18; H04B 17/327

(52) U.S. Cl. CPC H04L 12/2801; H04B 17/327; H04B 17/18; H04B 17/14

(57) ABSTRACT

Methods, systems, and computer readable media can be operable to facilitate a gathering and transmission of monitoring data from a sensor module to a telemetry control center. One or more sensor modules may be attached or otherwise connected to one or more devices that are included within an HFC infrastructure. Each sensor module may include one or more sensors that capture monitoring signals. The sensor module may interface with a communication link that is associated with the device to which it is connected. The sensor module may process the captured monitoring signals and output the processed signals to a telemetry control center, the processed signals being output over a reverse signal path that is utilized by the device to which the sensor module is connected.

### CROSS REFERENCE TO RELATED APPLICATION

This application is a non-provisional application claiming the benefit of U.S. Provisional Application Ser. No. 62/668,444, entitled “Telemetry Based on HFC Distribution Network Infrastructure,” which was filed on May 8, 2018, and is incorporated herein by reference in its entirety.

### TECHNICAL FIELD

This disclosure relates to a telemetry network that utilizes HFC (hybrid fiber coaxial) network infrastructure.

### BACKGROUND

Presently, a high level of business interest in wide range telemetry services has encouraged the development of network infrastructures, applications, technology platforms, and service concepts for monitoring purposes in urban areas. Although, satellite networks support a broad range of consumer and commercial applications for telemetry (e.g. GPS), specific monitoring services and systems require remote sensor nodes localized in ground for networking and accuracy. However, sensor access network investment and evolution is tied to factors such as: cost of deployment, potential operational savings, and competitive environments.

The cost contributor for new network infrastructure deployment is not only the capital expenditure required, but also the time necessary to get township approvals and negotiate with utility companies to install the communication links between sensors and central office. Therefore, the expenses required to install new network infrastructure has become a limitation for telemetry service providers to expand their networks in order to increase and localize new services and users. A need exists for improved methods and systems for providing telemetry services.

### BRIEF DESCRIPTION OF THE DRAWINGS

FIG. 1 is a block diagram illustrating an example HFC (hybrid fiber-coaxial) distribution network.

FIG. 2 is a block diagram illustrating an example telemetry network operable to facilitate a gathering and delivery of telemetry data using HFC infrastructure.

FIG. 3 is a block diagram illustrating an example sensor module operable to facilitate a gathering and delivery of telemetry data using HFC infrastructure.

FIG. 4 is a block diagram illustrating an example interconnection transceiver interface implemented as a virtual modem.

FIG. 5 is a block diagram illustrating an example interconnection transceiver interface implemented using data links of a DOCSIS status monitor transponder module.

FIG. 6 is a block diagram illustrating an example interconnection transceiver interface implemented using an independent P2P optical link to pass communications between a sensor module and a telemetry control center.

FIG. 7 shows an example configuration for a sensor module.

FIG. 8 shows an example illustration of a sensor module attached to a device.

FIG. 9 is a flowchart illustrating an example process operable to facilitate a gathering and transmission of monitoring data from a sensor module to a telemetry control center.

FIG. 10 is a block diagram of a hardware configuration operable to facilitate a gathering and transmission of monitoring data from a sensor module to a telemetry control center.

Like reference numbers and designations in the various drawings indicate like elements.

### DETAILED DESCRIPTION

It is desirable to improve upon methods and systems for providing telemetry services. Methods, systems, and computer readable media can be operable to facilitate a gathering and transmission of monitoring data from a sensor module to a telemetry control center. One or more sensor modules may be attached or otherwise connected to one or more devices that are included within an HFC infrastructure. Each sensor module may include one or more sensors that capture monitoring signals. The sensor module may interface with a communication link that is associated with the device to which it is connected. The sensor module may process the captured monitoring signals and output the processed signals to a telemetry control center, the processed signals being output over a reverse signal path that is utilized by the device to which the sensor module is connected.

Described herein is a system and method to utilize the existing Hybrid Fiber Coaxial (HFC) network infrastructure composed of headend resources, optical/RF links, remote nodes, amplifiers, and customer premise equipment (CPE), to implement a telemetry network for monitoring services. The monitored parameters may include, and are not limited to: temperature, humidity, rain fall, air quality, atmospheric pressure, air speed, earthquake sensors, video, audio, and in general any parameter that may be converted into an electrical signal trough a transducer.

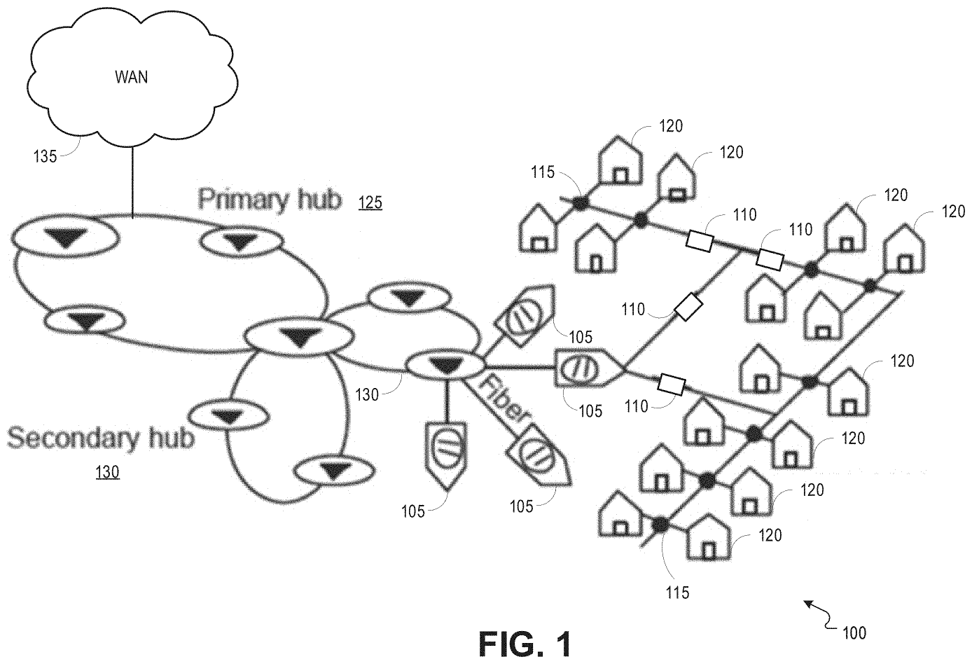

FIG. 1 is a block diagram illustrating an example HFC (hybrid fiber-coaxial) distribution network 100. The HFC distribution network 100 may include headend resources, remote nodes 105, RF (radio frequency) amplifiers 110, taps 115, and CPE (customer premise equipment) devices connected via coaxial cable or optical fiber. CPE devices may be located within customer premises 120. Headend resources may include a primary hub 125 comprising one or more optical amplifiers and transmitters and one or more secondary hubs 130 comprising one or more optical transmitters. The headend resources may include other devices or modules such as a cable modem termination system (CMTS), an edge quadrature amplitude modulation (EQAM) device, a combined or converged device including multiple edge and/or video or data processing functionalities, and various other devices. The headend resources may be bidirectionally connected with full-duplex links to remote nodes 105, RF amplifiers 110, and CPE devices using corresponding links for forward (downlink) and return (uplink) transmission. In embodiments, the terms “downstream” and “downlink” refer to the RF-optical path through which data signals are transmitted from the headend resources to the CPE devices. Similarly, the terms “upstream” and “uplink” refer to the RF-optical paths through which data signals are transmitted from the CPE devices to the head-end resources.

In embodiments, the headend resources may provide video, data and/or voice service(s) to one or more CPE devices. The CPE devices may include, set-top boxes (STB), gateway devices, cable modems, telephony devices, and other devices. The headend resources may operate to facilitate the delivery of communications between a WAN 135 (wide area network) and the CPE devices. In embodiments, a WAN 135 may include one or more networks internal to the headend resources and/or one or more networks external to the headend resources (e.g., one or more extranets, the Internet, etc.).

In embodiments, the headend resources may receive data signals from data sources (e.g., satellite feeds from television stations, data from websites on the Internet, music from online services, etc.). The data signals may include any type of information, such as video data, voice data, music data, and the like. The headend resources may process and/or transcode the data signals before generating and transmitting corresponding optical data signals over one or more fiber optic connections to one or more remote nodes 105. The remote nodes 105 may include optical distribution nodes. When the optical signals are received by a remote node 105, the signals may be converted from the optical domain (e.g., optical frequencies and protocols) to the electrical domain (e.g., RF signals and protocols) in the downstream optical/RF path. In embodiments, the downstream optical/RF path may include routing functionality for routing the resulting RF signals to one or more CPE devices over corresponding electrical connections (e.g., coaxial cables).

In embodiments, the CPE devices may generate RF signals (e.g., requests for data or voice data) and transmit them to a remote node 105. In the upstream RF/optical path, the RF signals are converted from the electrical domain to the optical domain. Conversion of the signals from the electrical domain to the optical domain includes the use of optical transmitters that may be driven by the electrical signals to generate corresponding optical signals (e.g., modulated signals of light).

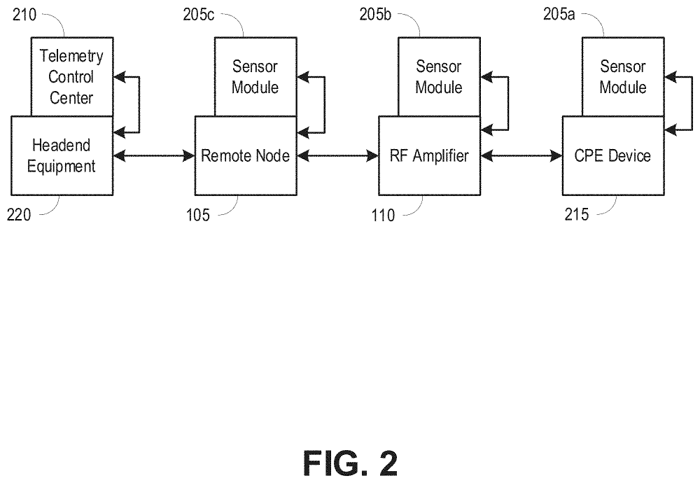

FIG. 2 is a block diagram illustrating an example telemetry network 200 operable to facilitate a gathering and delivery of telemetry data using HFC infrastructure. The telemetry network 200 may include one or more sensor modules 205a-c and a telemetry control center 210. In embodiments, sensor modules 205a-c may be attached, coupled, or mounted to equipment of an HFC network (e.g., HFC distribution network 100 of FIG. 1). For example, a sensor module 205a may be attached to a CPE device 215 (e.g., set-top box (STB), gateway device, cable modem, telephony device, or any other device located within a customer premise 120 of FIG. 1), a sensor module 205b may be attached to an RF amplifier 110, and a sensor module 205c may be attached to a remote node 105. In embodiments, a telemetry control center 210 may be connected to headend equipment 220. The headend equipment 220 may be a device that is included within headend resources, or the headend equipment 220 may comprise one or more headend resources (e.g., a primary hub 125 of FIG. 1 comprising one or more optical amplifiers and transmitters, one or more secondary hubs 130 of FIG. 1 comprising one or more optical transmitters, a CMTS, an EQAM device, a combined or converged device including multiple edge and/or video or data processing functionalities, and various other devices). Headend resources and infrastructure may be utilized to support the telemetry control center 210. For example, headend site facilities such as energy consumption and climate control may be used to host the telemetry control center 210.

The CPE device 215 and RF amplifier 110 may communicate over an RF link. The RF amplifier 110 and the remote node 105 may communicate over an RF link. The remote node 105 and the headend 220 equipment may communicate over an optical link.

In embodiments, each respective sensor module 205a-c may be powered using a power source of the device to which the respective sensor module 205a-c is attached. For example, a sensor module 205a-c may utilize power supplied from an RF link (e.g., 60 VAC from a coaxial cable). As another example, a sensor module 205a-c may utilize converted DC voltage from a power supply of the device to which the sensor module 205a-c is attached, wherein the converted DC voltage is determined based upon a calculation of a power consumption margin considering the addition of the sensor module 205a-c.

In embodiments, each respective sensor module 205a-c may use the links (e.g., telecommunication links such as RF links, optical links, etc.) between the equipment of the HFC network to control and monitor data that is generated at the respective sensor module 205a-c. For example, full duplex communications over the RF links may be facilitated by utilizing DOCSIS (data over cable service interface specification) HFC schemes for forward (e.g., subcarrier multiplexing (SCM)) and return (e.g., time division multiple access (TDMA), code division multiple access (CDMA), etc.). As another example, small form-factor pluggable (SFP) transceivers may be used to pass communications over an optical link using a wavelength division multiplexing (WDM) scheme.

In embodiments, each respective one sensor module 205a-c may have a unique MAC (media access control) address, and the respective one sensor module 205a-c may be identified by other sensor modules 205a-c and the telemetry control center 210 through the unique MAC address.

In the forward direction, the telemetry control center 210 may send acknowledge and control data to each of the one or more sensor modules 205a-c. In the return direction, sensor modules 205a-c may transmit sensor data (e.g., telemetry data) to the telemetry control center 210, wherein the sensor data includes monitoring data that is gathered by each of one or more sensors that are installed on each sensor module 205a-c.

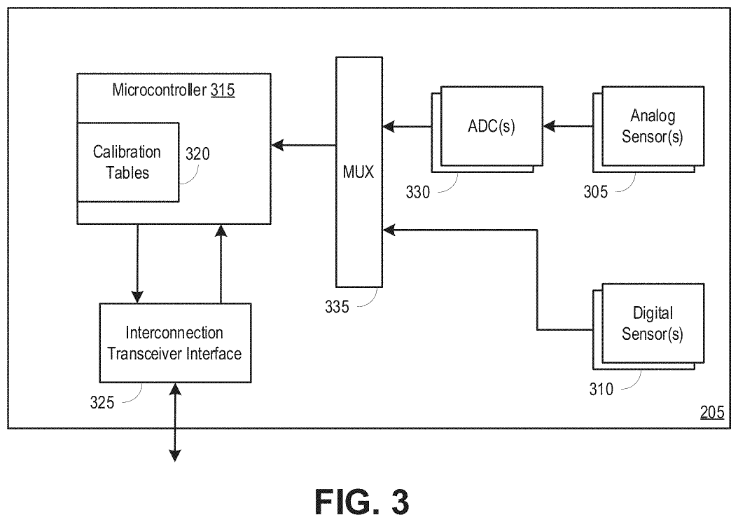

FIG. 3 is a block diagram illustrating an example sensor module 205 operable to facilitate a gathering and delivery of telemetry data using HFC infrastructure. The sensor module 205 may include one or more analog sensors 305 and/or one or more digital sensors 310 that are controlled by a microcontroller 315. A calibration table 320 (e.g., a calibration table or look-up table) for each of the one or more sensors (e.g., analog sensor(s) 305 and/or digital sensor(s) 310) may be hosted by the microcontroller 315. The one or more sensors may collect signals such as, but not limited to: temperature; humidity; rain fall; video; audio; air quality metrics; atmospheric pressure; wind speed; earthquake metrics; and any other signal that may be measured, converted electrically, and transported via an HFC distribution network (e.g., HFC distribution network 100 of FIG. 1).

In embodiments, an interconnection transceiver interface 325 may facilitate sensor data transmission and control data reception through an HFC distribution network (e.g., HFC distribution network 100). The interconnection transceiver interface 325 may be configured based upon a communication scheme that is associated with a device to which the sensor module 205 is connected. For example, the interconnection transceiver interface 325 may be implemented using different approaches depending upon certain requirements for transmitting and/or receiving data. In embodiments, the interconnection transceiver interface 325 may be implemented as a virtual modem installed at active HFC equipment (e.g., remote node 105, RF amplifier 110, CPE device 215, etc.). In embodiments, the interconnection transceiver interface 325 may be implemented using data links of a DOCSIS status monitor transponder module which provides the ability to manage remote nodes and optical hubs through a DOCSIS infrastructure. In embodiments, the interconnection transceiver interface 325 may be implemented using an independent P2P (point-to-point) optical link to pass communications between the sensor module 205 and a telemetry control center 210 of FIG. 2. The selection of the implementation of the interconnection transceiver interface 325 may depend, for example, on the type and configuration of the device to which the sensor module 205 is connected, as shown in Table 1.

TABLE 1

| HFC active device | Virtual modem DOCSIS | DOCSIS Transponder | P2P optical link |
|---|---|---|---|
| Remote Node | It can be implemented using RF test | DOCSIS transponder must be | Optical passives for |
| | points or RF couplers for SM Forward | installed into the node to | MUX/DEMUX can be reused or |
| | and Return communication | implement this option. | new WDM passive is required |
| | | | for SM optical links. |
| RF Amplifier | It can be implemented using RF test | Most of the HFC RF amplifiers do | Because an HFC optical link is |
| | points or RF couplers for SM Forward | not have DOCSIS transponder. | not available at the RF amplifier. |
| | and Return communication | Thus, this implementation may | This implementation may |
| | | require RF amplifier changes to | require fiber link installation. |
| | | include the transponder. | |
| CPE | RF test point do not exist at the CPE. | An implementation at the | For coaxial cable CPEs this |
| | Therefore, it can be implemented with | telemetry link will require | implementation may require |
| | external RF couplers and a Diplexer is | hardware and software changes | fiber link installation. However, |
| | required at SM input. | at the CPE. | for optical CPEs only an optical |
| | | | passive to MUX/DEMUX SM |
| | | | optical signals is required. |

The sensor module 205 may utilize full-duplex communication with one or more headend resources (e.g., a telemetry control center 210 that is connected to headend equipment 220 of FIG. 2).

In embodiments, monitoring signals captured by the analog sensor(s) 305 may be converted to digital signals by one or more ADCs (analog-to-digital converters) 330 before being output for transmission to a telemetry control center 210 of FIG. 2.

In embodiments, the sensor module 205 may include a multiplexer 335. Monitoring signals captured by the analog sensor(s) 305 and/or digital sensor(s) 310 may be multiplexed by the multiplexer 335 before being output for transmission to a telemetry control center 210.

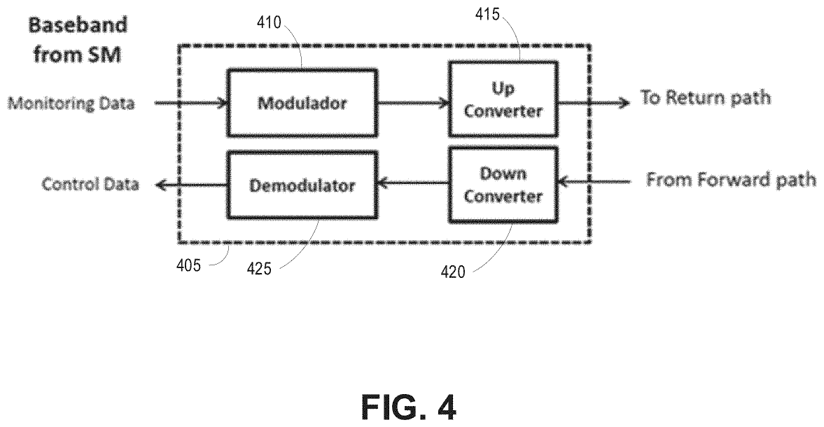

FIG. 4 is a block diagram illustrating an example interconnection transceiver interface implemented as a virtual modem 405. The interconnection transceiver interface (e.g., interconnection transceiver interface 325 of FIG. 3) of a sensor module 205 of FIG. 2 may be implemented as a virtual modem 405 that is installed into active HFC equipment (e.g., remote node 105, RF amplifier 110, CPE device 215, etc.). The sensor module 205 may be recognized by the HFC equipment as a DOCSIS device. Corresponding configuration changes may be made at a headend (e.g., headend equipment 220 of FIG. 2) such that sensor data received from sensor modules 205a-c in the return direction is demultiplexed, and control data is multiplexed and sent in the forward direction towards corresponding sensor modules 205a-c.

In embodiments, monitoring data received from the sensor module 205 may be processed by a modulator 410 and an up converter 415 before being transmitted along the return path.

In embodiments, a control signal carrying control data may be received by the virtual modem 405 from a forward path, and the control signal may be processed by a down converter 420 and demodulator 425 before being output to the sensor module 205.

In embodiments, the interconnection transceiver interface may facilitate a connection between the sensor module 205 and an RF link. For example, an RF coupler (e.g., 90:10 or other configuration based upon the device to which the sensor module 205 is attached) may be installed at the RF forward path to take a portion of the forward signal to the sensor module 205, while another RF coupler may be connected to the RF return path to introduce a monitoring signal from the sensor module 205. The monitoring signal may carry monitoring data that is gathered by the sensor module 205. The location and configuration of the RF couplers may be dependent upon the type and configuration of a device to which the sensor module 205 is connected. As another example, the device to which the sensor module 205 is connected may include one or more RF test points, and RF signals may be transmitted from and received by the sensor module 205 through the one or more RF test points. Monitoring signals (e.g., signals carrying sensor data that is gathered by the sensor module 205) may be introduced to return path test points of the device to which the sensor module 205 is connected, and control signals transmitted from a telemetry control center 210 of FIG. 2 may be collected by the sensor module 205 from forward test points of the device to which the sensor module 205 is connected. The interconnection transceiver interface may include one or more RF amplifiers (e.g., monolithic microwave integrated circuit (MMIC)) to compensate for RF test point losses.

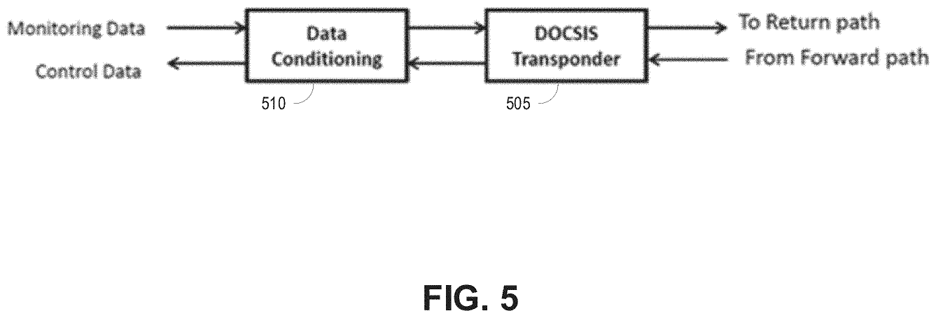

FIG. 5 is a block diagram illustrating an example interconnection transceiver interface implemented using data links of a DOCSIS status monitor transponder module. In embodiments a sensor module 205 of FIG. 2 may be connected to a DOCSIS transponder 505 (e.g., DOCSIS status monitor transponder module) of a device (e.g., a remote node 105 of FIG. 1). The DOCSIS transponder 505 may receive control signals from a telemetry control center 210 of FIG. 2 over a forward path and may transmit monitoring data (e.g., sensor data gathered by the sensor module 205) to the telemetry control center 210 over a return path. The DOCSIS transponder 505 may transmit monitoring data using SNMP (simple network management protocol). The DOCSIS transponder 505 may be assigned an IP (Internet protocol) address that may be used to access the monitoring data via SNMP. Monitoring data may be compatible with ANSI SCTE HMS standards.

In embodiments, monitoring signals carrying monitoring data and control signals carrying control data may be processed by a data conditioning module 510.

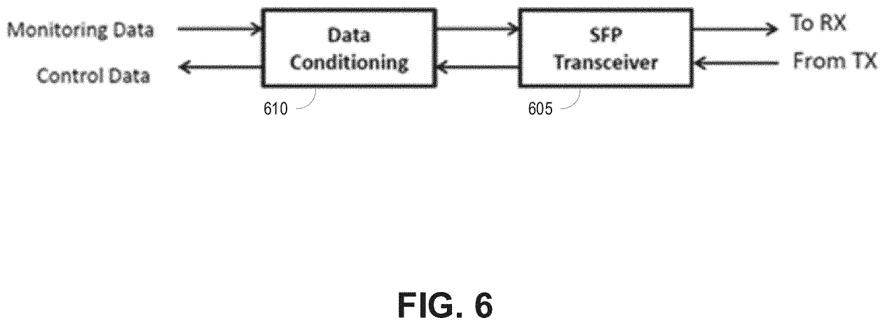

FIG. 6 is a block diagram illustrating an example interconnection transceiver interface implemented using an independent P2P optical link to pass communications between a sensor module 205 of FIG. 2 and a telemetry control center 210 of FIG. 2. In embodiments, the sensor module 205 may include a transceiver (e.g., SFP transceiver 605). Transmitter and receiver signals may be multiplexed and demultiplexed into a device to which the sensor module is connected, and the device may transport the signals along HFC optical fibers used by the device for forward and return using the WDM scheme. The optical channels for the sensor module optical link may be selected according to the optical passives that are available to the device to which the sensor module 205 is connected. In embodiments, an additional WDM passive may be installed for multiplexing/demultiplexing.

In embodiments, monitoring signals carrying monitoring data and control signals carrying control data may be processed by a data conditioning module 610.

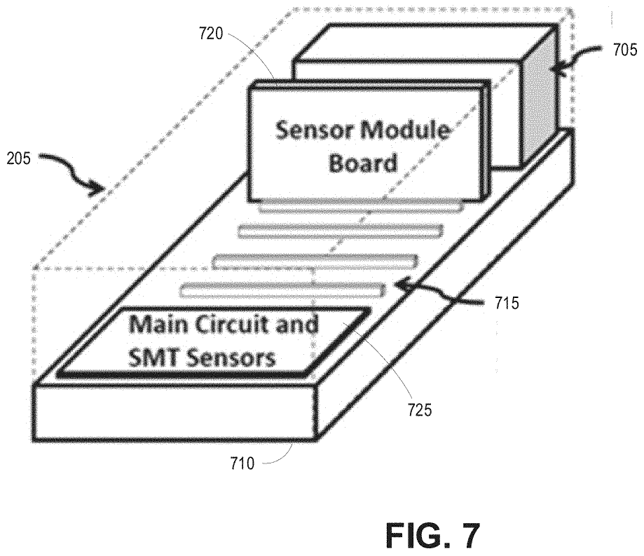

FIG. 7 shows an example configuration for a sensor module 205. The sensor module 205 may include one or more sensors 705 that are implemented into a PCB (printed circuit board) 710 using surface mount technology (SMT). The sensor module 205 may include one or more sensor slots 715 (e.g., plug-in boards) into which one or more interchangeable sensors may be installed. Different interchangeable sensors may be interchanged depending upon the type of telemetry data that is to be gathered by the sensor module 205. The sensor module 205 may include a sensor module board 720 and a main circuit and SMT sensors module 725

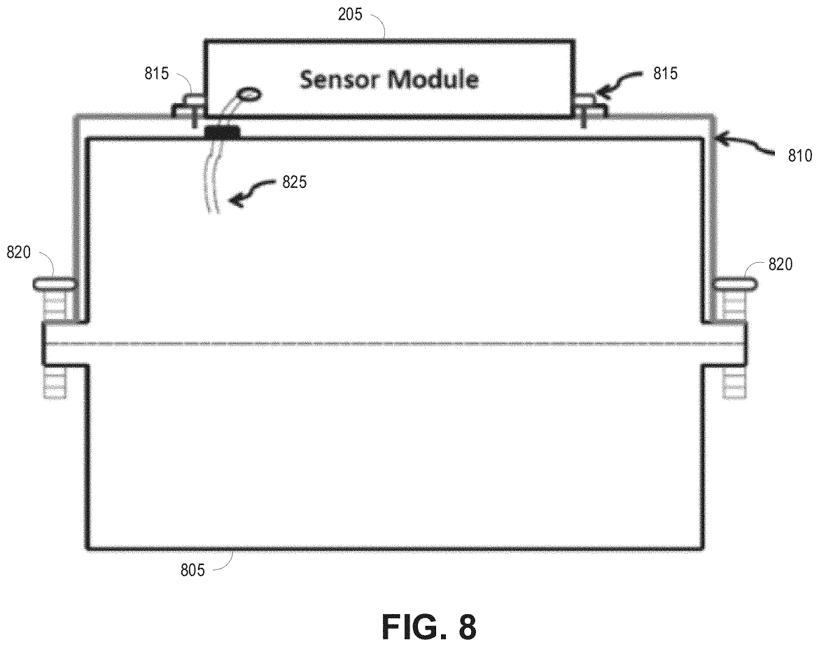

FIG. 8 shows an example illustration of a sensor module 205 attached to a device. The sensor module 205 may be attached to an HFC device 805 (e.g., remote node 105 of FIG. 1, RF amplifier 110 of FIG. 1, CPE device 215 of FIG. 2, etc.). For example, the sensor module 205 may be clamped to the HFC device 805 or may be attached to the HFC device with one or more screws or other type of connector. As another example, the sensor module 205 may be attached to a harness 810 with one or more screws 815 or other type of connector, and the harness 810 may be attached to an enclosure of the HFC device 805 with one or more screws 820 or other type of connector. Communications may be passed between the sensor module 205 and the HFC device 805 over one or more cables 825.

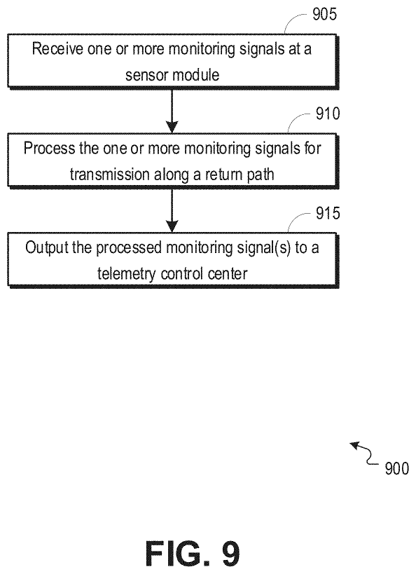

FIG. 9 is a flowchart illustrating an example process 900 operable to facilitate a gathering and transmission of monitoring data from a sensor module to a telemetry control center. The process 900 may begin at 905 when one or more monitoring signals are received at a sensor module. The monitoring signals may be received at a sensor module 205 of FIG. 2 (e.g., by one or more analog sensors 305 of FIG. 3 and/or digital sensors 310 of FIG. 3). The monitoring signals may include temperature, humidity, rain fall, video, audio, air quality metrics, atmospheric pressure, wind speed, earthquake metrics, and any other signal that may be measured, converted electrically, and transported via an HFC distribution network (e.g., HFC distribution network 100 of FIG. 1).

At 910, the one or more monitoring signals may be processed for transmission along a return path. The one or more monitoring signals may be processed, for example, by the sensor module 205. In embodiments, an interconnection transceiver interface 325 of FIG. 3 may process the one or more monitoring signals for transmission along a return path (e.g., an RF or optical link).

At 915, the one or more processed monitoring signals may be output to a telemetry control center 210 of FIG. 2. For example, the processed monitoring signal(s) may be passed from the sensor module 205 to a device to which the sensor module 205 is connected or attached (e.g., an HFC device), and the processed monitoring signal(s) may be transmitted from the device to the telemetry control center 210 via a return path link. As another example, the processed monitoring signal(s) may be transmitted from the sensor module 205 to the telemetry control center 210 via a return path link.

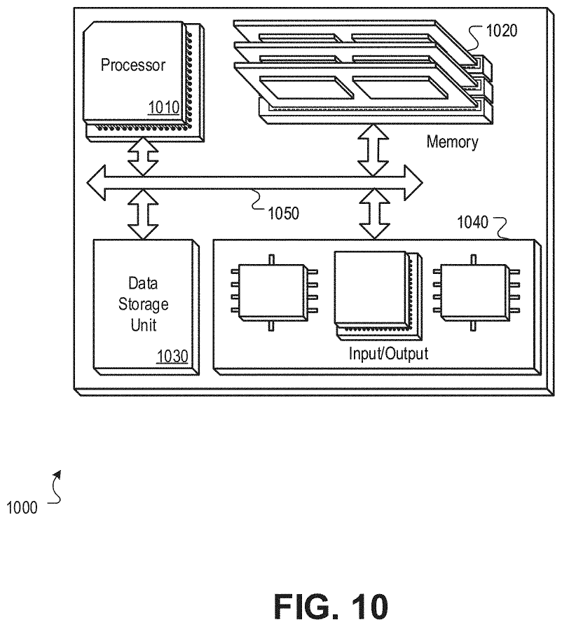

FIG. 10 is a block diagram of a hardware configuration 1000 operable to facilitate a gathering and transmission of monitoring data from a sensor module to a telemetry control center. The hardware configuration 1000 can include a processor 1010, a memory 1020, a storage device 1030, and an input/output device 1040. Each of the components 1010, 1020, 1030, and 1040 can, for example, be interconnected using a system bus 1050. The processor 1010 can be capable of processing instructions for execution within the hardware configuration 1000. In one implementation, the processor 1010 can be a single-threaded processor. In another implementation, the processor 1010 can be a multi-threaded processor. The processor 1010 can be capable of processing instructions stored in the memory 1020 or on the storage device 1030.

The memory 1020 can store information within the hardware configuration 1000. In one implementation, the memory 1020 can be a computer-readable medium. In one implementation, the memory 1020 can be a volatile memory unit. In another implementation, the memory 1020 can be a non-volatile memory unit.

In some implementations, the storage device 1030 can be capable of providing mass storage for the hardware configuration 1000. In one implementation, the storage device 1030 can be a computer-readable medium. In various different implementations, the storage device 1030 can, for example, include a hard disk device, an optical disk device, flash memory or some other large capacity storage device. In other implementations, the storage device 1030 can be a device external to the hardware configuration 1000.

The input/output device 1040 provides input/output operations for the hardware configuration 1000. In one implementation, the input/output device 1040 can include one or more of a network interface device (e.g., an Ethernet card), a serial communication device (e.g., an RS-232 port), one or more universal serial bus (USB) interfaces (e.g., a USB 2.0 port), one or more wireless interface devices (e.g., an 802.11 card), and/or one or more interfaces for outputting video, voice, and/or data services to a display device. In embodiments, the input/output device can include driver devices configured to send communications to, and receive communications from one or more networks, HFC devices, and/or CPE devices over optical and/or RF return and/or forward paths.

Those skilled in the art will appreciate that the invention improves upon methods and systems for providing telemetry services. Methods, systems, and computer readable media can be operable to facilitate a gathering and transmission of monitoring data from a sensor module to a telemetry control center. One or more sensor modules may be attached or otherwise connected to one or more devices that are included within an HFC infrastructure. Each sensor module may include one or more sensors that capture monitoring signals. The sensor module may interface with a communication link that is associated with the device to which it is connected. The sensor module may process the captured monitoring signals and output the processed signals to a telemetry control center, the processed signals being output over a reverse signal path that is utilized by the device to which the sensor module is connected.

The subject matter of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD ROM disks. The processor and the memory can be supplemented by, or incorporated in, special purpose logic circuitry.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

We claim:

1. A method comprising:
receiving one or more monitoring signals at a sensor module, wherein the sensor module is attached to a network device;
processing the one or more monitoring signals for transmission along a return path;
outputting the one or more processed monitoring signals to a telemetry control center, wherein the one or more processed monitoring signals are transmitted to the telemetry control center over one or more return paths.

2. The method of claim 1, wherein the telemetry control center is attached to a headend resource.

3. The method of claim 1, wherein the sensor module is powered by a power supply of the network device.

4. The method of claim 1, wherein the one or more monitoring signals are received by one or more sensors that are implemented into a printed circuit board of the sensor module.

5. The method of claim 4, wherein a calibration table for each of the one or more sensors is hosted by a microcontroller of the sensor module.

6. The method of claim 1, wherein the sensor module is configured to process the one or more monitoring signals for transmission along a return path based upon a type of link that is utilized by the network device.

7. The method of claim 1, wherein the sensor module is configured to receive the one or more monitoring signals based upon one or more control signals that are received from the telemetry control center, wherein the one or more control signals are received by the sensor module via one or more forward paths.

8. A sensor module comprising:
one or more sensors that receive one or more monitoring signals;
one or more modules that:
process the one or more monitoring signals for transmission along a return path that is utilized by a network device to which the sensor module is attached; and
output the one or more processed monitoring signals to a telemetry control center, wherein the one or more processed monitoring signals are transmitted to the telemetry control center over the return path that is utilized by the network device.

9. The sensor module of claim 8, wherein the sensor module is powered by a power supply of the network device.

10. The sensor module of claim 8, wherein the one or more sensors are implemented into a printed circuit board of the sensor module.

11. The sensor module of claim 10, wherein a calibration table for each of the one or more sensors is hosted by a microcontroller of the sensor module.

12. The sensor module of claim 8, wherein the one or more modules process the one or more monitoring signals for transmission along the return path based upon a type of link that is utilized by the network device.

13. The sensor module of claim 8, wherein the sensor module is configured to receive the one or more monitoring signals based upon one or more control signals that are received from the telemetry control center, wherein the one or more control signals are received by the sensor module via one or more forward paths.

14. One or more non-transitory computer readable media having instructions operable to cause one or more processors to perform the operations comprising:
receiving one or more monitoring signals at a sensor module, wherein the sensor module is attached to a network device;
processing the one or more monitoring signals for transmission along a return path;
outputting the one or more processed monitoring signals to a telemetry control center, wherein the one or more processed monitoring signals are transmitted to the telemetry control center over one or more return paths.

15. The one or more non-transitory computer-readable media of claim 14, wherein the telemetry control center is attached to a headend resource.

16. The one or more non-transitory computer-readable media of claim 14, wherein the sensor module is powered by a power supply of the network device.

17. The one or more non-transitory computer-readable media of claim 14, wherein the one or more monitoring signals are received by one or more sensors that are implemented into a printed circuit board of the sensor module.

18. The one or more non-transitory computer-readable media of claim 17, wherein a calibration table for each of the one or more sensors is hosted by a microcontroller of the sensor module.

19. The one or more non-transitory computer-readable media of claim 14, wherein the sensor module is configured to process the one or more monitoring signals for transmission along a return path based upon a type of link that is utilized by the network device.

20. The one or more non-transitory computer-readable media of claim 14, wherein the sensor module is configured to receive the one or more monitoring signals based upon one or more control signals that are received from the telemetry control center, wherein the one or more control signals are received by the sensor module via one or more forward paths.
